(19) United States
(12) Patent Application Publication
(10) Pub. No.: US 2026/0330431 A1
(43) Pub. Date: Oct. 22, 2026

(54) SYSTEM AND METHOD FOR ROLE-BASED VIRTUAL FAMILY MATCHING WITH COMPLEMENTARY ROLE PAIRING AND EXPERIENTIAL RELATIONSHIP REINFORCEMENT

(71) Applicant: Jazmin Jaff, San Diego, CA (US)

(72) Inventor: Jazmin Jaff, San Diego, CA (US)

(21) Appl. No.: 19/630,518

(22) Filed: Mar. 27, 2026

Related U.S. Application Data
(60) Provisional application No. 63/792,315, filed on Apr. 22, 2025.

(51) Int. Cl. G06Q 10/42

(52) U.S. Cl. CPC G06Q 10/42

(57) ABSTRACT

A computer-implemented system and method for forming and managing virtual family relationships. Users select desired family roles from a predefined family-role taxonomy and are matched with other users seeking complementary family roles through a matching engine governed by a role compatibility ruleset comprising constraint tables that define permitted and prohibited role pairings. Upon mutual acceptance, the system generates a persistent role-labelled relationship object comprising a family-role label and a relationship state, wherein transitions between relationship states govern communication permissions between matched users. The system surfaces family-oriented experiences and updates matching model parameters based on experiential participation data and post-interaction feedback, thereby establishing a reinforcement feedback loop in which shared experiential participation influences subsequent compatibility scoring.

### CROSS-REFERENCE TO RELATED APPLICATIONS

This application claims the benefit of U.S. Provisional Application No. 63/792,315, filed Apr. 22, 2025, titled “iFam,” the entire disclosure of which is incorporated herein by reference.

### FIELD OF INVENTION.

The present invention relates generally to computer-implemented social networking systems and, more particularly, to systems and methods for forming, managing, and reinforcing persistent virtual family relationships through role-based user matching governed by a role compatibility ruleset, persistent role-labelled relationship objects with state-dependent permission governance, and an experiential reinforcement feedback loop.

### BACKGROUND

Social networking platforms have proliferated across a wide range of interpersonal domains since the early 2000s. Platforms such as Facebook, Instagram, and LinkedIn organize users into peer-to-peer connection graphs in which relationships are modeled as undifferentiated edges between nodes, typically labeled as “friends,” “followers,” or “connections.” These graph structures treat all interpersonal associations as functionally equivalent, regardless of the nature, depth, or role-specific character of the underlying relationship. A user's connection to a casual acquaintance is stored and governed in the same manner as a connection to a close confidant or a familial figure. While such platforms have achieved broad adoption for general social interaction, professional networking, and content sharing, they provide no technical architecture for representing, forming, or maintaining relationships that are structured around defined interpersonal roles—and in particular, they provide no mechanism by which a user may seek, discover, and establish a relationship with another user on the basis of complementary familial role intent.

A separate category of platforms has emerged to address romantic relationship formation. Systems such as those disclosed in U.S. Pat. No. 6,735,568 to eHarmony, Inc. and U.S. Pat. No. 6,272,467 to Match. com LLC employ profile-driven bilateral compatibility assessment, in which structured user attributes are collected, weighted, and compared to generate compatibility scores between candidate pairs. These systems have contributed meaningful advances in algorithmic matching methodology, including multi-factor scoring, two-way preference analysis, and staged communication escalation gated by compatibility thresholds. However, these platforms are architecturally oriented toward romantic pairing. The matching objective is to identify individuals who are similar to one another across a range of personality and preference dimensions—that is, the matching is similarity-based. There is no concept of complementary role pairing, in which a first user seeking to fulfill one interpersonal role is matched with a second user seeking to fulfill a reciprocal or complementary role. The relationship objects generated by these systems, to the extent they exist as persistent data structures at all, are not labeled according to defined interpersonal roles and do not carry state machines governing ongoing communication permissions, discovery visibility, or event eligibility.

A further body of prior art addresses role-differentiated matching in professional and educational contexts. U.S. Patent Application Publication No. 2006/0031087 to MentorNet discloses a system for bi-directionally matching mentors and protégés in online environments, in which mentor profiles and protégé profiles are evaluated against one another to produce recommended pairings. U.S. Patent Application Publication No. 2018/0300818, originally filed by LinkedIn Corporation, discloses a similar system for matching mentors and mentees using social networking data. These references establish that the general architectural pattern of assigning users to defined roles and performing bilateral preference-based matching between those roles is known. However, these systems are confined to a single role pair—mentor and protégé, or mentor and mentee—operating within a professional or educational context. There is no disclosure of a multi-role family taxonomy encompassing parent, child, sibling, grandparent, and non-biological family figure roles, no role compatibility ruleset implemented as constraint tables defining permitted and prohibited pairings across such a taxonomy, and no persistent role-labelled relationship objects that track state transitions and govern ongoing permissions. The mentoring pairings created by these systems are typically time-limited and programme-dependent, and they terminate upon programme completion rather than persisting as stateful relationship objects with ongoing governance functions.

Non-patent platforms operating in adjacent spaces further illustrate the gap. Applications such as Peanut connect mothers and women at similar life stages through swipe-based friendship matching, but operate within a single demographic category and do not implement a family-role taxonomy or complementary role pairing. Papa matches young adults with seniors for paid companionship and assistance in a service-oriented rather than family-role-oriented context. Bumble BFF applies swipe-based matching to platonic friendship without any role assignment or family-oriented experiential features. Big Brothers Big Sisters, using an AI Match Recommendation Engine developed with KPMG, represents perhaps the most sophisticated non-patent example of algorithmic role-based pairing for quasi-familial relationships, but operates within a single mentor-mentee role pair in an organisational context rather than across a multi-role family taxonomy. None of these platforms discloses the combination of a predefined family-role taxonomy with a role compatibility ruleset, persistent role-labelled relationship objects governed by a relationship state machine, and an experiential reinforcement feedback loop in which shared participation in family-oriented events and experiences influences future match quality.

A further deficiency common to all of the foregoing systems is the absence of any mechanism by which the ongoing conduct of a matched relationship feeds back into and improves the matching process itself. Existing matching platforms treat the matching decision as a terminal event: once two users are paired, the matching engine's involvement ends. There is no feedback pathway by which post-match interaction data—including joint participation in shared activities, communication frequency and quality, relationship longevity, and user-reported satisfaction—is recorded, aggregated, and used to update matching model parameters for subsequent users. The absence of such a feedback loop means that the matching algorithm operates on static profile data alone and cannot learn from the observed outcomes of its own pairing decisions. There is accordingly a need in the art for a computer-implemented system that enables users to select desired family roles from a predefined taxonomy, matches users on the basis of complementary role pairings governed by a role compatibility ruleset, generates persistent role-labelled relationship objects with state-dependent permission governance, and establishes a reinforcement feedback loop in which shared experiential participation between matched users influences subsequent compatibility scoring and match ranking.

It is within this context that the present invention is provided.

### SUMMARY

In one embodiment, the present invention provides a computer-implemented method for forming and managing virtual family relationships. The method is performed by one or more processors and includes receiving, from a first user, structured profile data and a selection of at least one desired family role from a predefined family-role taxonomy comprising a plurality of distinct family roles. A role compatibility ruleset comprising at least one constraint table defining permitted pairings and prohibited pairings among the plurality of distinct family roles is queried to identify candidate users whose stored family-role selections correspond to a complementary family-role pairing with the selected family role of the first user. For each candidate user having a complementary family-role pairing, a compatibility score is calculated, and one or more ranked candidate profiles are presented to the first user via a discovery interface based on the calculated compatibility scores. Upon mutual acceptance between the first user and a second user, a persistent role-labelled relationship object is generated. The relationship object comprises a family-role label derived from the respective family-role selections of the first user and the second user and a relationship state, wherein transitions between relationship states govern at least communication permissions between the first user and the second user. One or more family-oriented experiences are surfaced to the first user and the second user, and one or more parameters of a matching model are updated based at least in part on experiential participation data and post-interaction feedback associated with the family-oriented experiences, thereby establishing a reinforcement feedback loop in which shared experiential participation influences subsequent compatibility scoring.

In certain embodiments, the family-role taxonomy comprises at least parent roles, child roles, sibling roles, and grandparent roles. The compatibility score may be calculated based on a plurality of weighted parameters comprising at least role compatibility, age alignment, and geographic proximity. The relationship object may be distinct from friend, follower, and contact graph associations, and the relationship state may be selectable from at least active, suspended, and terminated, with transitions between relationship states further governing discovery visibility and event eligibility. In certain embodiments, at least one communication channel between matched users is gated based on both the relationship state and a trust tier associated with the relationship object, and the trust tier may be progressively elevated responsive to positive relationship health signals derived from the experiential participation data and the post-interaction feedback. The method may further comprise monitoring communications between matched users for prohibited content and, responsive to detecting a violation, triggering a safety action comprising at least one of suspending the relationship object, restricting communication permissions, or escalating to a moderation queue.

In another embodiment, the present invention provides a system for forming and managing virtual family relationships. The system comprises one or more processors and a non-transitory storage medium storing processor-executable instructions that, when executed by the one or more processors, cause the system to implement a profile module configured to receive and store structured profile data and a family-role selection from each of a plurality of users, the family-role selection drawn from a predefined family-role taxonomy comprising a plurality of distinct family roles; a role compatibility ruleset comprising at least one constraint table defining permitted pairings and prohibited pairings among the plurality of distinct family roles; a matching engine configured to identify, for a given user, candidate users whose stored family-role selections correspond to a complementary family-role pairing as defined by the role compatibility ruleset, and to calculate for each candidate user a compatibility score; a discovery interface configured to present ranked candidate profiles to the given user based on the calculated compatibility scores; a relationship management module configured to, upon mutual acceptance between users, generate a persistent role-labelled relationship object comprising a family-role label and a relationship state, wherein transitions between relationship states govern at least communication permissions; and an experiences module configured to surface family-oriented experiences and to update one or more parameters of a matching model based at least in part on experiential participation data and post-interaction feedback, thereby establishing a reinforcement feedback loop in which shared experiential participation influences subsequent compatibility scoring performed by the matching engine.

In yet another embodiment, the present invention provides a non-transitory computer-readable medium storing processor-executable instructions that, when executed by one or more processors, cause the one or more processors to perform operations for forming and managing virtual family relationships. The operations include receiving structured profile data and family-role selections from users, querying a role compatibility ruleset to identify complementary family-role pairings, calculating compatibility scores and presenting ranked candidate profiles, generating persistent role-labelled relationship objects upon mutual acceptance, and surfacing family-oriented experiences while updating matching model parameters based on experiential participation data and post-interaction feedback to establish a reinforcement feedback loop.

### BRIEF DESCRIPTION OF THE DRAWINGS

Various embodiments of the invention are disclosed in the following detailed description and accompanying drawings.

FIG. 1 is a block diagram illustrating a system architecture for a role-based virtual family and family figure matching platform in accordance with an embodiment of the present invention.

FIG. 2 is a flow diagram illustrating a method for user onboarding and role-based family matching performed by the system of FIG. 1.

FIG. 3 is a flow diagram illustrating a method for relationship lifecycle management and experiential reinforcement performed by the system of FIG. 1.

FIG. 4A is a screenshot of a discovery interface presenting matched user profiles with family-role indicators in accordance with an embodiment of the present invention.

FIG. 4B is a screenshot of a connections interface displaying active virtual family relationships in accordance with an embodiment of the present invention.

FIG. 4C is a screenshot of an experiences interface displaying available family-oriented events and shared experiences in accordance with an embodiment of the present invention.

FIG. 4D is a screenshot of a messages interface enabling communication between matched family members in accordance with an embodiment of the present invention.

FIG. 4E is a screenshot of a profile detail view displaying user attributes and family-role information in accordance with an embodiment of the present invention.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.
The term “family-role taxonomy” refers to a predefined, system-stored set of selectable family roles and family figure roles from which each user must select at least one desired role during onboarding. The taxonomy includes traditional familial roles such as mother, father, daughter, son, sister, brother, grandmother, and grandfather, as well as non-biological family figure roles including mentor-like and guardian-type family figures that function as family relationships without requiring legal or biological kinship. The taxonomy is not open-ended; it is a closed set defined and maintained by the system.
The term “complementary family-role pairing” refers to a pairing between two users whose respective family-role selections are reciprocal or compatible as determined by the role compatibility ruleset. Complementary role pairing is distinguished from similarity-based matching in that the two users need not share similar attributes or preferences; rather, each user seeks to fulfill a different familial role relative to the other. By way of example, a user seeking a mother role and a user seeking a daughter role may constitute a complementary family-role pairing, whereas two users both seeking a mother role would not, unless the role compatibility ruleset expressly permits such a pairing.
The term “role compatibility ruleset” refers to one or more constraint tables stored in a non-transitory storage medium that define, for each family role in the family-role taxonomy, the set of permitted pairings, prohibited pairings, and, in certain embodiments, conditional pairings with other family roles. The role compatibility ruleset operates as a hard constraint on all downstream matching and discovery operations such that no user pairing that violates the ruleset may be presented through the discovery interface or result in the generation of a relationship object.
The term “relationship object” refers to a persistent, role-labelled data structure stored in a non-transitory storage medium and generated upon mutual acceptance between two users. Each relationship object comprises at least a family-role label derived from the dual family-role selections of the matched users, a relationship state, and associated metadata. The relationship object is structurally and functionally distinct from friend, follower, and contact graph edges employed by conventional social networking platforms, in that it carries a defined familial role label and a state machine governing ongoing permissions.
The term “relationship state” refers to the current status of a relationship object within a defined state machine. Relationship states include at least pending, active, suspended, and terminated. Transitions between relationship states may be triggered by user action, system action, moderation action, or elapsed time, and each state governs the communication permissions, discovery visibility, and event eligibility associated with the corresponding relationship object.
The term “trust tier” refers to a graduated permission level associated with a relationship object that determines the scope of communication channels and interaction features available to the matched users. Trust tiers may be elevated over time responsive to positive relationship health signals including communication regularity, co-participation in family-oriented experiences, positive post-interaction feedback, and absence of safety flags.
The term “family-oriented experience” refers to an event or shared activity surfaced by the system to users having an active relationship object. Family-oriented experiences may include physical gatherings, virtual events, holiday celebrations, seasonal activities, and other structured interactions. Each family-oriented experience includes metadata comprising at least a title, category, date, location, and participant capacity.
The term “reinforcement feedback loop” refers to the data pathway by which experiential participation data and post-interaction feedback generated during or following family-oriented experiences are recorded, aggregated, and fed back to the matching model, such that one or more parameters of the matching model are updated and subsequent compatibility scoring and match ranking are influenced by observed experiential outcomes. The reinforcement feedback loop is distinguished from static, one-time matching in that the matching model continuously improves based on post-match behavioral data rather than operating solely on pre-match profile attributes.

Unless expressly stated otherwise, words such as “a,” “an,” and “the” are intended to include both singular and plural forms, and the term “about” is intended to accommodate ±10 % variations in stated values. Recitation of a range inherently includes all sub-ranges and individual values within that range. All exemplary materials, temperatures, and dimensions may be interchanged with other functionally equivalent counterparts unless contradicted by express language. The scope of the invention should therefore be construed in light of the appended claims, with these passages serving only to illustrate representative but non-limiting embodiments.

### DETAILED DESCRIPTION OF DRAWINGS

The present invention addresses the deficiencies of existing social networking, romantic matching, and mentor-matching platforms by providing an integrated computer-implemented system and method in which users select desired family roles from a predefined taxonomy, are matched with other users seeking complementary family roles through a matching engine governed by a role compatibility ruleset, and form persistent virtual family relationships that are tracked, managed, and reinforced over time. Unlike conventional platforms that model all interpersonal connections as undifferentiated graph edges or that confine role-based matching to a single professional role pair, the present invention implements a multi-role family taxonomy spanning parent, child, sibling, grandparent, and non-biological family figure roles, and enforces a constraint-table-based ruleset that restricts matching to permitted complementary pairings. Upon mutual acceptance, the system generates a persistent role-labelled relationship object that is distinct from conventional friend, follower, or contact associations and that carries a relationship state machine governing communication permissions, discovery visibility, and event eligibility over the lifecycle of the relationship. The system further surfaces family-oriented experiences and events to matched users and implements a reinforcement feedback loop in which joint participation in those experiences generates data that is fed back to the matching model, such that the quality and relevance of future matches are continuously refined based on observed relationship outcomes rather than static profile data alone. The combination of role-governed complementary matching, persistent stateful relationship objects, and experiential reinforcement within a single family-role-centric platform represents a technical architecture that is not disclosed or suggested by any individual reference or combination of references in the prior art.

The following detailed description is provided with reference to the accompanying drawings, which form a part of this specification. Like reference numerals designate like elements throughout the several views. The detailed description is illustrative and not limiting, and the scope of the invention is defined by the appended claims and equivalents thereof.

The following detailed description is provided with reference to the accompanying drawings, which form a part of this specification. Like reference numerals designate like elements throughout the several views. The detailed description is illustrative and not limiting, and the scope of the invention is defined by the appended claims and equivalents thereof.

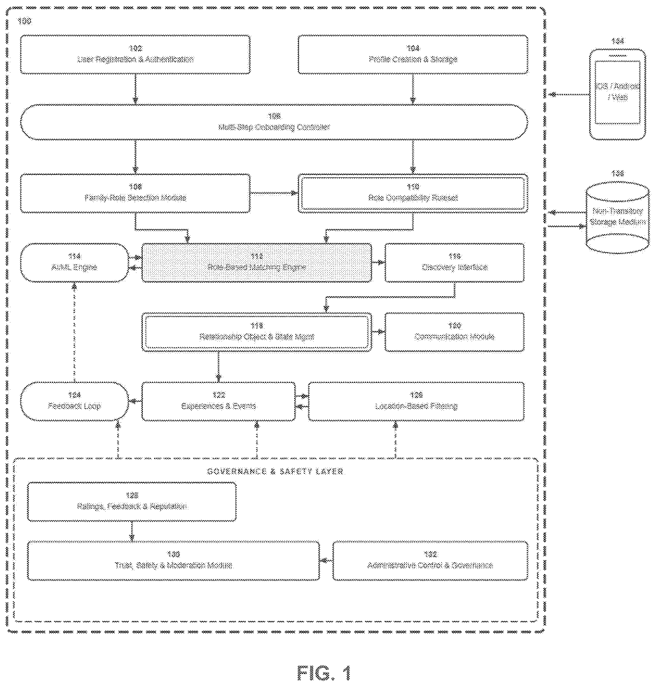

Referring now to FIG. 1, there is illustrated a system architecture for a role-based virtual family and family figure matching platform, designated generally by reference numeral 100. The system 100 comprises a plurality of interconnected software modules configured to cooperate in the creation, management, and reinforcement of persistent virtual family relationships between users. The system 100 is implemented on one or more servers or distributed computing environments and is accessible by users through a user device 134, which may comprise a mobile device running an iOS or Android application, a web browser, or any combination thereof. Data generated and consumed by the modules of the system 100 is stored in and retrieved from a non-transitory storage medium 136, which may comprise one or more databases, object stores, or file storage systems. The bidirectional data flow between the system 100 and the non-transitory storage medium 136 reflects that each module may both read from and write to persistent storage during operation.

The system 100 includes a user registration and authentication module 102 configured to receive registration requests from new users, verify user credentials, enforce age-gating requirements, and issue authenticated session tokens. In certain embodiments, the user registration and authentication module 102 supports multiple authentication mechanisms including email and password authentication, third-party identity providers, and federated sign-in services. The system 100 further includes a profile creation and storage module 104 configured to receive, validate, and store structured profile data from each user. Profile data may include, by way of example and not limitation, age, geographic location, education level, language preferences, personal values, lifestyle attributes, interests and hobbies, religious or spiritual preferences, and family-orientation indicators. The profile creation and storage module 104 stores each user's profile as a structured data record in the non-transitory storage medium 136 and enforces minimum completeness thresholds prior to enabling downstream matching functionality.

A multi-step onboarding controller 106 orchestrates the sequential progression of each user through a series of mandatory and optional onboarding steps. The multi-step onboarding controller 106 receives outputs from the user registration and authentication module 102 and the profile creation and storage module 104 and coordinates the presentation of onboarding stages including account creation, profile data entry, location authorization, media upload, and family-role intent selection. The multi-step onboarding controller 106 may present progress indicators to the user and may prevent access to discovery, matching, or communication features until all mandatory onboarding steps are completed.

The system 100 includes a family-role selection module 108 configured to present a dedicated interface requiring the user to explicitly select one or more desired family roles or family figure roles. Selectable roles include, by way of example and not limitation, mother, father, daughter, son, sister, brother, grandmother, grandfather, and non-biological family figure roles including mentor-like and guardian-type family figures. The family-role selection module 108 stores the selected role as a primary matching constraint associated with the user's profile record. Role selection is mandatory and serves as the principal axis distinguishing the system 100 from generic social networking platforms.

The selected role is validated against a role compatibility ruleset 110, which is implemented as one or more constraint tables defining permitted pairings, prohibited pairings, and conditional pairings among family roles and family figure roles. The role compatibility ruleset 110 operates as a hard constraint such that no downstream matching or discovery operations may present a user pairing that violates the ruleset. For example, a user seeking a mother role may be eligible to match with a user seeking a daughter role, while a user seeking a mother role may be ineligible to match with another user also seeking a mother role, unless the ruleset explicitly permits such pairing. The role compatibility ruleset 110 may further enforce age-alignment constraints, role exclusivity rules, and relationship cardinality limits. The double-bordered representation of the role compatibility ruleset 110 in FIG. 1 indicates its function as a persistent constraint store that governs the behavior of other modules.

A role-based matching engine 112 receives as inputs the user's stored role intent from the family-role selection module 108, the constraint outputs from the role compatibility ruleset 110, and the structured profile data from the profile creation and storage module 104 (via the non-transitory storage medium 136). The role-based matching engine 112 performs asymmetric and complementary matching, wherein a first user seeks a first family role and a second user seeks a reciprocal or compatible family role. The role-based matching engine 112 calculates compatibility scores using weighted parameters including role compatibility, age alignment, geographic proximity, shared values, and lifestyle compatibility. The role-based matching engine 112 is designated as architecturally significant in FIG. 1, reflecting its central position in the system's data flow.

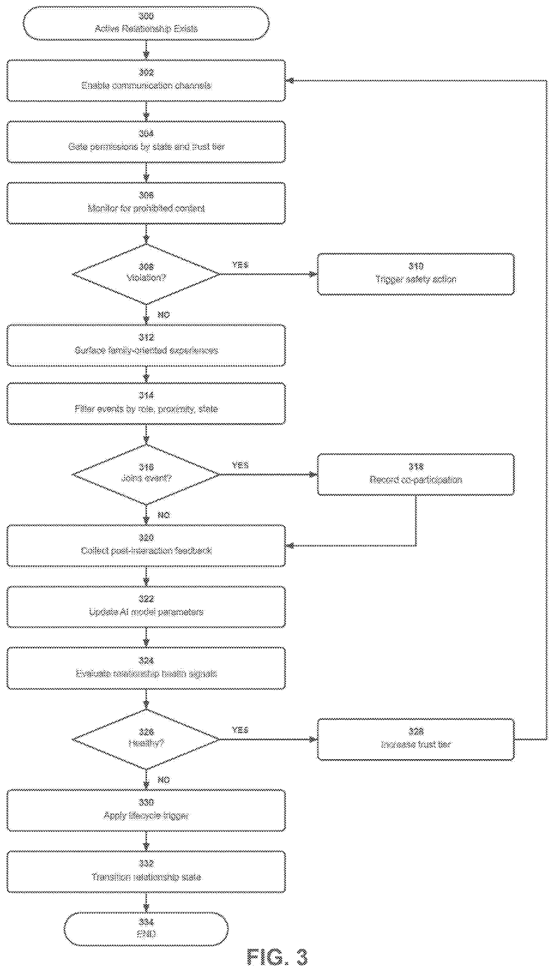

The role-based matching engine 112 operates in bidirectional communication with an AI/ML engine 114, which comprises one or more artificial intelligence and machine-learning models configured to identify optimal family-role matches among a plurality of users. The AI/ML engine 114 evaluates structured and unstructured profile data, historical interaction data, messaging behavior, and participation in shared experiences to generate compatibility scores and ranking outputs. Model parameters within the AI/ML engine 114 may be periodically updated based on feedback signals, as described further with reference to FIG. 3. The AI/ML engine 114 operates within the role-governed constraints established by the role compatibility ruleset 110, such that artificial intelligence optimization cannot override mandatory role rules, safety constraints, or age restrictions.

Ranked match outputs from the role-based matching engine 112 are delivered to a discovery interface 116, which presents matched profiles to the user in a catalog-style format enabling acceptance, rejection, or deferral. The discovery interface 116 displays, for each presented profile, the user's profile imagery, role label, age and distance indicators, profile attributes, and interaction controls. User actions within the discovery interface 116 are recorded and may influence future match visibility and ranking.

Upon mutual acceptance between two users through the discovery interface 116, a relationship object and state management module 118 generates a persistent role-labeled relationship object stored in the non-transitory storage medium 136. The relationship object is distinct from conventional friend, follower, or contact graph edges and is labeled according to the role pairing derived from the dual role intent selections of the matched users. The relationship object and state management module 118 tracks relationship state over time, with states including pending, active, suspended, and terminated. State transitions may affect communication permissions, discovery visibility, and event eligibility. The double-bordered representation of the relationship object and state management module 118 in FIG. 1 indicates its function as a persistent data store.

Once a virtual family relationship is active, a communication module 120 enables communication between matched users through text messaging, voice communication, and video communication. Communication permissions within the communication module 120 may be gated based on relationship state, trust tier, and safety flags. Message content may be monitored or filtered in accordance with trust and safety policies enforced by the trust, safety, and moderation module 130.

An experiences and events module 122 enables users to create, host, browse, and join family-oriented events and shared experiences. Each experience includes metadata comprising a title, category, date and time, location, participant capacity, and role relevance metadata. Family-oriented experiences may include holiday dinners, seasonal celebrations, family gatherings, and virtual or hybrid events. The experiences and events module 122 communicates bidirectionally with a location-based filtering module 126, which filters and surfaces nearby matches, local family-oriented experiences, and events based on geographic proximity. Location data may be obtained via GPS, device-based location services, or manually entered geographic data.

A feedback loop 124 receives interaction data and participation signals from the experiences and events module 122 and feeds updated parameters back to the AI/ML engine 114. This feedback pathway, represented in FIG. 1 as a dashed arrow indicating governance and feedback flow, implements the experiential reinforcement mechanism of the system 100: participation in shared experiences generates feedback data that is used to refine the AI/ML engine's compatibility scoring and match ranking outputs over time. The feedback loop 124 thereby creates a reinforcement cycle in which the quality and relevance of future matches are continuously improved based on observed user behavior and interaction outcomes.

The system 100 further includes a governance and safety layer comprising a ratings, feedback, and reputation module 128, a trust, safety, and moderation module 130, and an administrative control and governance module 132. The ratings, feedback, and reputation module 128 receives user-generated ratings, reviews, and feedback signals associated with virtual family relationships, shared experiences, and user interactions. These signals are aggregated, weighted, and fed to the trust, safety, and moderation module 130 for evaluation.

The trust, safety, and moderation module 130 is configured to enforce non-romantic participation, detect prohibited behavior, apply risk-gated discovery controls, manage trust tiers and verification levels, and execute moderation workflows including warnings, temporary communication suspension, role revocation, and account restriction or removal. The trust, safety, and moderation module 130 exercises governance oversight over the core operational modules of the system 100, as indicated by the dashed arrows rising from the governance and safety layer to the modules above in FIG. 1.

In certain embodiments, identity verification status of a user, including completion of third-party identity verification, government-issued identification review, or biometric verification, serves as an input to the trust tier assigned to that user's relationship objects, such that verified users may receive an elevated initial trust tier and correspondingly expanded communication permissions and event eligibility.

The administrative control and governance module 132 provides centralized administrative controls enabling authorized personnel to access moderation dashboards, review flagged interactions, revoke or modify assigned family roles, suspend or terminate accounts, and override automated system decisions. The administrative control and governance module 132 feeds directives to the trust, safety, and moderation module 130 for execution. Audit logs may be maintained to record administrative actions and system decisions.

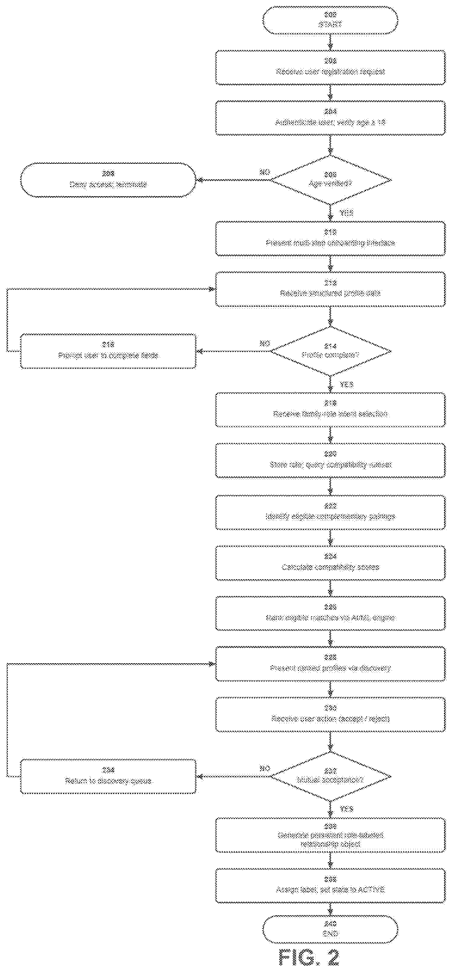

Referring now to FIG. 2, there is illustrated a method for user onboarding and role-based family matching performed by the system 100 of FIG. 1. The method begins at step 200 and proceeds through a sequence of registration, profile creation, role selection, matching, and relationship formation steps that collectively implement the computer-implemented method of Independent Claim 1.

At step 202, the system receives a user registration request from a user device 134. The registration request includes at minimum a set of user credentials and may further include acceptance of platform terms and age-related waivers. The registration request is processed by the user registration and authentication module 102 of FIG. 1.

At step 204, the system authenticates the user and verifies that the user's age meets or exceeds a minimum threshold, which in certain embodiments is eighteen years of age. Authentication may comprise verification of email and password credentials, validation through a third-party identity provider, or federated sign-in. Age verification may comprise self-reported date of birth entry, third-party age verification services, or other verification mechanisms.

At decision step 206, the system determines whether the user's age has been verified as meeting the minimum threshold. If the user's age is not verified (NO branch), the method proceeds to step 208, at which the system denies access to the platform and terminates the registration process. The user may be presented with an informational message indicating the reason for denial. If the user's age is verified (YES branch), the method proceeds to step 210.

At step 210, the system presents a multi-step onboarding interface to the user, orchestrated by the multi-step onboarding controller 106 of FIG. 1. The onboarding interface guides the user through a sequence of mandatory and optional steps including profile data entry, location authorization, media upload, and family-role intent selection. Progress indicators may be displayed to the user to visually represent completion status.

At step 212, the system receives structured profile data from the user through the onboarding interface. Structured profile data may include, by way of example and not limitation, age, geographic location, education level, language preferences, personal values, lifestyle attributes, interests and hobbies, religious or spiritual preferences, and family-orientation indicators. The received profile data is stored as a structured data record by the profile creation and storage module 104.

At decision step 214, the system evaluates whether the user's profile meets a predefined completeness threshold. The completeness threshold may require population of all mandatory fields, upload of at least one profile image, and provision of location data. If the profile does not meet the completeness threshold (NO branch), the method proceeds to step 216, at which the system prompts the user to complete the remaining mandatory fields. The method then returns to step 212 to receive additional profile data, thereby creating a loop that continues until the completeness threshold is satisfied. If the profile meets the completeness threshold (YES branch), the method proceeds to step 218.

At step 218, the system receives a family-role intent selection from the user. The user is presented with a dedicated interface, implemented by the family-role selection module 108 of FIG. 1, requiring explicit selection of one or more desired family roles or family figure roles. Selectable roles include, by way of example and not limitation, parent roles, child roles, sibling roles, grandparent roles, and non-biological family figure roles including mentor-like and guardian-type family figures. Role selection is mandatory and cannot be deferred or bypassed.

At step 220, the system stores the selected family-role intent as a primary matching constraint associated with the user's profile record and queries the role compatibility ruleset 110 of FIG. 1 to determine which complementary or reciprocal roles are eligible for pairing with the user's selected role. The role compatibility ruleset 110 returns a set of permitted role pairings and excludes any prohibited or conditionally ineligible pairings.

At step 222, the system identifies eligible users whose stored role intent selections correspond to a complementary role pairing as defined by the role compatibility ruleset 110. This identification is performed by the role-based matching engine 112 of FIG. 1, which queries the non-transitory storage medium 136 for users satisfying role compatibility constraints and minimum profile completeness requirements.

At step 224, the system calculates compatibility scores for each eligible user pairing using weighted parameters. These parameters include, by way of example and not limitation, role compatibility, age alignment, geographic proximity, shared values, and lifestyle compatibility. Each parameter is assigned a weight that may be configured by the system or, in certain embodiments, learned through machine-learning optimization.

At step 226, the AI/ML engine 114 of FIG. 1 ranks the eligible matches based on the calculated compatibility scores, historical interaction data, feedback signals, and any additional contextual factors. The ranking process produces an ordered list of candidate profiles for presentation to the user. Artificial intelligence ranking operates within the constraints established by the role compatibility ruleset 110, such that no candidate may appear in the ranked output unless role compatibility is satisfied.

At step 228, the system presents the ranked profiles to the user through the discovery interface 116 of FIG. 1. Each presented profile includes the candidate's profile imagery, family-role label, age and distance indicators, selected profile attributes, and interaction controls enabling the user to accept, reject, or defer the presented profile.

At step 230, the system receives a user action in response to a presented profile. The user action may comprise acceptance, rejection, or deferral. Each action is recorded and may influence future match visibility and ranking. Upon acceptance by the first user, the system determines whether the candidate user has also accepted the first user.

At decision step 232, the system evaluates whether mutual acceptance exists between the two users. If mutual acceptance does not exist (NO branch), the method proceeds to step 234, at which the system returns the first user to the discovery queue and the method loops back to step 228 to present additional ranked profiles. If mutual acceptance exists (YES branch), the method proceeds to step 236.

At step 236, the system generates a persistent role-labeled relationship object, implemented by the relationship object and state management module 118 of FIG. 1. The relationship object is stored in the non-transitory storage medium 136 and is distinct from conventional friend, follower, or contact graph edges used by existing social networking platforms.

At step 238, the system assigns a family-role label to the relationship object. The label is derived from the dual role intent selections of the matched users, such that a first user's intent and a second user's intent jointly determine the label applied to the relationship. For example, if a first user selected “Daughter” and a second user selected “Mom,” the relationship object is labeled accordingly. The system sets the relationship state to ACTIVE, thereby enabling downstream communication and experiential participation as described with reference to FIG. 3.

The method terminates at step 240. Upon termination, the newly formed virtual family relationship is accessible to both users through their respective connection interfaces, and the system is configured to enable communication and shared experiences as governed by the relationship state, trust tier, and safety controls.

Referring now to FIG. 3, there is illustrated a method for managing the lifecycle of a virtual family relationship and reinforcing that relationship through shared experiential participation. The method of FIG. 3 operates on an active relationship object generated at step 236 of FIG. 2 and implements the experiential reinforcement feedback loop that distinguishes the system 100 from conventional social networking architectures.

The method begins at step 300, at which an active virtual family relationship exists between a first user and a second user. The relationship is stored as a persistent role-labeled relationship object in the non-transitory storage medium 136 of FIG. 1, with its relationship state set to ACTIVE.

At step 302, the system enables communication channels between the matched users. Communication channels include text messaging, voice communication, and video communication, implemented by the communication module 120 of FIG. 1. The availability and scope of communication features may vary based on relationship state, trust tier, and entitlement level.

At step 304, the system gates communication permissions based on the current relationship state and trust tier of the participating users. Users assigned to a higher trust tier may be granted expanded communication privileges, including access to voice and video calling, while users in a probationary or newly formed relationship may be restricted to text messaging. Permission gating is enforced by the trust, safety, and moderation module 130 of FIG. 1 in conjunction with the relationship object and state management module 118.

At step 306, the system monitors communication content for prohibited material, including romantic or sexual language, dating solicitations, behavior inconsistent with declared family roles, and other content that violates platform safety policies. Monitoring may be performed through automated content filtering, natural language processing, pattern detection, or a combination thereof.

At decision step 308, the system determines whether a content violation has been detected. If a violation is detected (YES branch), the method proceeds to step 310, at which the system triggers a safety action. Safety actions may include, by way of example and not limitation, issuance of an automated warning, temporary communication suspension, role revocation, relationship suspension, or account restriction or removal. The severity of the safety action is determined by the nature and frequency of the detected violation and may be escalated through moderation review by the administrative control and governance module 132. If no violation is detected (NO branch), the method proceeds to step 312.

At step 312, the system surfaces family-oriented experiences to the matched users. Experiences are provided by the experiences and events module 122 of FIG. 1 and may include holiday dinners, seasonal celebrations, family gatherings, and virtual or hybrid events. Experiences may be created by other users of the platform or by the system itself as algorithmically generated suggestions.

At step 314, the system filters the available experiences based on role compatibility, geographic proximity, relationship state, trust tier, and role relevance metadata. Filtering is performed in conjunction with the location-based filtering module 126 of FIG. 1, which applies geographic radius thresholds and jurisdictional constraints. The filtering step ensures that only experiences relevant to the users' family-role pairing and geographic context are presented.

At decision step 316, the system determines whether one or both of the matched users elects to join a presented experience. If a user joins an experience (YES branch), the method proceeds to step 318, at which the system records the co-participation event in the relationship object stored in the non-transitory storage medium 136. The co-participation record includes metadata identifying the experience, the participating users, the date and time of participation, and the users' respective family-role labels. The method then continues to step 320. If neither user joins an experience (NO branch), the method proceeds directly to step 320.

At step 320, the system collects post-interaction feedback from the participating users. Feedback may include ratings, qualitative reviews, trust or reliability indicators, and moderation-weighted feedback signals. Feedback collection is facilitated by the ratings, feedback, and reputation module 128 of FIG. 1. Feedback signals may be aggregated, weighted, anonymized, or partially suppressed to prevent retaliation or gaming.

At step 322, the system updates the parameters of the AI/ML engine 114 of FIG. 1 using the collected feedback data. Updated parameters may include compatibility scoring weights, ranking factors, predictive relationship longevity indicators, and role recommendation confidence scores. This parameter update step implements the machine-learning refinement component of the feedback loop 124 depicted in FIG. 1, whereby observed interaction outcomes are used to improve future matching accuracy.

At step 324, the system evaluates relationship health signals for the active relationship. Health signals may include communication frequency, message sentiment, co-participation frequency, feedback scores, time elapsed since last interaction, and any outstanding safety flags or moderation outcomes. The evaluation produces a composite health indicator used at the subsequent decision step.

At decision step 326, the system determines whether the relationship is healthy based on the evaluated health signals. If the relationship is determined to be healthy (YES branch), the method proceeds to step 328, at which the system increases the trust tier associated with the relationship and may expand communication permissions, event hosting privileges, and discovery visibility for the participating users. From step 328, the method returns to step 302, thereby re-entering the communication and experiential reinforcement cycle. This return path, routed along the right margin of FIG. 3, represents the feedback loop that is central to the operation of the system 100: healthy relationships are continuously reinforced through repeated cycles of communication, shared experiential participation, feedback collection, AI model refinement, and trust tier advancement.

If the relationship is determined to be unhealthy (NO branch at decision step 326), the method proceeds to step 330, at which the system applies a lifecycle trigger. Lifecycle triggers may include detection of prolonged inactivity, accumulation of negative feedback, receipt of a safety report, failure to participate in shared experiences, or detection of behavior inconsistent with declared family roles.

At step 332, the system transitions the relationship state in response to the applied lifecycle trigger. State transitions may include transitioning the relationship from ACTIVE to SUSPENDED, from ACTIVE to TERMINATED, or from ACTIVE to a cooling period during which communication and co-participation are restricted. State transitions update the relationship object in the non-transitory storage medium 136 and may affect communication permissions, discovery visibility, and event eligibility for the participating users. In certain embodiments, the system may initiate a re-matching workflow in which one or both users are surfaced alternative family-role matches through the discovery interface 116.

The method terminates at step 334. Termination of the method of FIG. 3 indicates that the relationship has exited the active reinforcement cycle, either through suspension, termination, or transition to a re-matching workflow. Users whose relationships have been terminated may re-enter the matching process of FIG. 2 at step 228 to be presented with new candidate profiles.

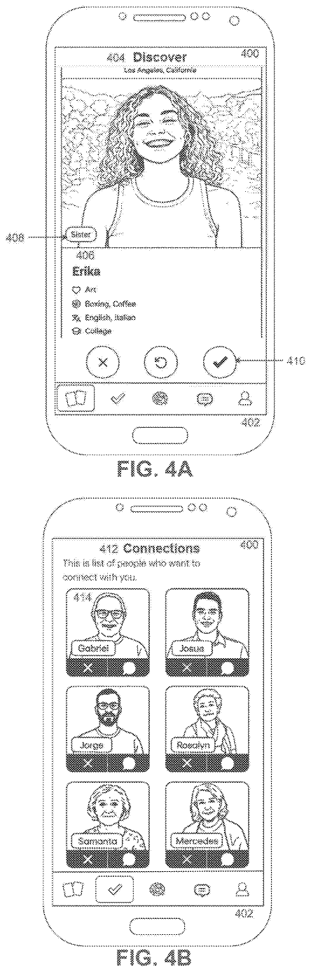

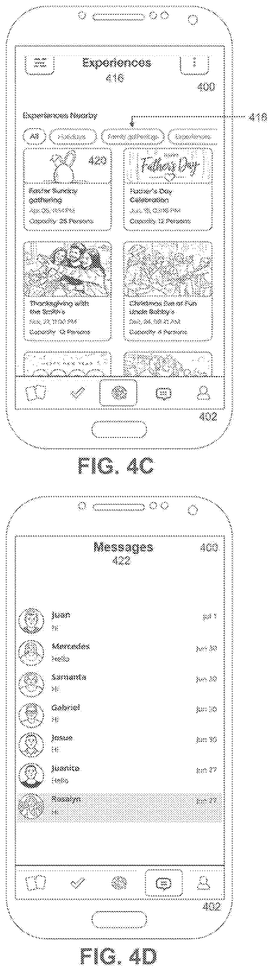

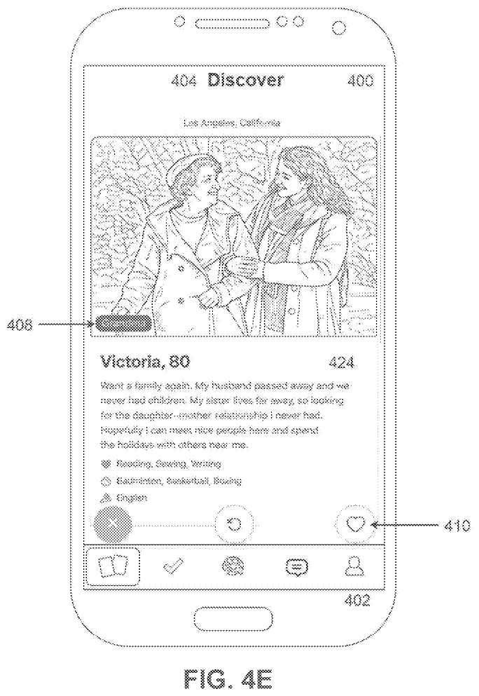

Referring now to FIGS. 4A through 4E, there are illustrated exemplary user interface views of a mobile application interface 400 implementing the system 100 of FIG. 1. The mobile application interface 400 is rendered on a user device 134, which may comprise a smartphone, tablet, or other computing device having a display and input capability. Each of FIGS. 4A through 4E depicts a distinct functional screen of the application, accessible to the user through a navigation bar 402 disposed at the bottom of the mobile application interface 400. The navigation bar 402 provides persistent access to the principal functional areas of the application, including discovery, connections, experiences, and messages, and is visible across the views depicted in FIGS. 4A through 4D. Each tab within the navigation bar 402 corresponds to a functional module of the system 100 described with reference to FIG. 1.

Referring specifically to FIG. 4A, there is illustrated a discovery interface 404 corresponding to the discovery interface 116 of FIG. 1. The discovery interface 404 presents matched user profiles to the viewing user in a catalog-style format, displaying one profile at a time for evaluation. Each presented profile is rendered as a profile card 406 comprising the candidate user's profile imagery, name, and structured profile attributes including interests, languages, and education level. A geographic location indicator is displayed above the profile card 406, indicating the candidate user's city and state or region.

The profile card 406 includes a family-role label indicator 408 displayed as a badge overlaid on or adjacent to the profile imagery. The family-role label indicator 408 identifies the candidate user's declared family-role intent, such as “Sister” in the exemplary view of FIG. 4A. The family-role label indicator 408 is derived from the role intent stored by the family-role selection module 108 and validated against the role compatibility ruleset 110 of FIG. 1, such that only profiles having a complementary role pairing with the viewing user are presented in the discovery interface 404.

Disposed below the profile card 406 are interaction controls 410 enabling the viewing user to take an action on the presented profile. The interaction controls 410 include, in the exemplary embodiment depicted, a rejection control, an acceptance control, and a deferral or secondary action control. Actuation of the acceptance control records an acceptance signal and, if the candidate user has also accepted the viewing user, initiates the relationship formation process described at steps 236 and 238 of FIG. 2. Actuation of the rejection control removes the candidate from the viewing user's discovery queue, and the discovery interface 404 advances to the next ranked profile.

Referring now to FIG. 4B, there is illustrated a connections interface 412 presenting a grid of pending and active virtual family relationship requests. The connections interface 412 implements a view of the relationship object and state management module 118 of FIG. 1, displaying users who have expressed interest in forming a virtual family relationship with the viewing user or with whom the viewing user has an existing relationship.

Each pending connection is rendered as a connection request card 414 comprising the candidate user's profile imagery, name, and accept and reject controls. The connection request card 414 enables the viewing user to confirm or decline a pending relationship request. Upon mutual confirmation through the connection request card 414, the system generates a persistent role-labeled relationship object as described at step 236 of FIG. 2, and the confirmed connection transitions from the pending state to the active state within the connections interface 412.

Referring now to FIG. 4C, there is illustrated an experiences interface 416 corresponding to the experiences and events module 122 of FIG. 1. The experiences interface 416 presents family-oriented events and shared experiences available to the viewing user, filtered by geographic proximity through the location-based filtering module 126.

The experiences interface 416 includes category filter tabs 418 disposed at the top of the event listing area. The category filter tabs 418 enable the user to narrow the displayed experiences by category, including by way of example “All,” “Holidays,” “Family gatherings,” and “Experiences.” Selection of a category filter tab 418 causes the system to filter the presented events and display only those events matching the selected category.

Below the category filter tabs 418, the experiences interface 416 displays a plurality of experience event cards 420, each representing a discrete family-oriented event. Each experience event card 420 comprises an event image or illustration, event title, date and time, and participant capacity information. The experience event cards 420 depicted in the exemplary view of FIG. 4C include seasonal and holiday-themed events such as an Easter Sunday gathering, a Father's Day celebration, a Thanksgiving gathering, and a Christmas Eve event, each displaying a capacity indicator reflecting the maximum number of participants permitted. Selection of an experience event card 420 navigates the user to an event detail view providing additional information and participation controls, as described in the detailed description of FIG. 7.

Referring now to FIG. 4D, there is illustrated a messages interface 422 corresponding to the communication module 120 of FIG. 1. The messages interface 422 presents a scrollable list of active conversation threads between the viewing user and users with whom the viewing user has an active virtual family relationship. Each conversation thread entry comprises a circular profile avatar, the matched user's name, a preview of the most recent message, and a date indicator. The conversation threads are arranged in reverse chronological order, with the most recently active thread positioned at the top of the list. In the exemplary view of FIG. 4D, one conversation thread is depicted in a highlighted state, indicating an unread message or a selected thread. Communication within the messages interface 422 is gated by relationship state and trust tier as described at steps 302 and 304 of FIG. 3, such that messaging is available only between users having an active virtual family relationship.

Referring now to FIG. 4E, there is illustrated a profile detail view 424 representing an expanded view of a candidate user's profile within the discovery interface 404 of FIG. 4A. The profile detail view 424 displays the candidate user's profile imagery at an enlarged scale, the candidate user's name and age, and a biographical text field in which the candidate user has provided a free-form personal narrative. Below the biographical text, the profile detail view 424 presents structured profile attributes including interests, sports and hobbies, and languages, rendered as labeled attribute rows.

The profile detail view 424 includes a family-role label indicator 408 identifying the candidate user's declared family-role intent, which in the exemplary view of FIG. 4E is “Grandmother.” The family-role label indicator 408 in the profile detail view 424 is the same element as the family-role label indicator 408 depicted in FIG. 4A, demonstrating that the role label persists and is visible to the viewing user in both the summary card format and the expanded detail format. The biographical narrative displayed in the profile detail view 424 of FIG. 4E illustrates a use case in which an elderly user expresses a desire to form virtual family connections after the loss of biological family members, demonstrating the system's application to users experiencing social isolation or familial disconnection.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for forming and managing virtual family relationships, the method performed by one or more processors and comprising:
receiving, from a first user, structured profile data and a selection of at least one desired family role from a predefined family-role taxonomy comprising a plurality of distinct family roles;
querying a role compatibility ruleset comprising at least one constraint table defining permitted pairings and prohibited pairings among the plurality of distinct family roles to identify candidate users whose stored family-role selections correspond to a complementary family-role pairing with the selected family role of the first user;
for each candidate user having a complementary family-role pairing, calculating a compatibility score and presenting, via a discovery interface, one or more ranked candidate profiles to the first user based on the calculated compatibility scores;
upon mutual acceptance between the first user and a second user, generating a persistent role-labelled relationship object comprising a family-role label derived from the respective family-role selections of the first user and the second user and a relationship state, wherein transitions between relationship states govern at least communication permissions between the first user and the second user; and
surfacing one or more family-oriented experiences to the first user and the second user, and updating one or more parameters of a matching model based at least in part on experiential participation data and post-interaction feedback associated with the family-oriented experiences, thereby establishing a reinforcement feedback loop in which shared experiential participation influences subsequent compatibility scoring.

2. The method of claim 1, wherein the family-role taxonomy comprises at least parent roles, child roles, sibling roles, and grandparent roles.

3. The method of claim 1, wherein the compatibility score is calculated based on a plurality of weighted parameters comprising at least role compatibility, age alignment, and geographic proximity.

4. The method of claim 1, wherein the relationship object is distinct from friend, follower, and contact graph associations, and wherein the relationship state is selectable from at least active, suspended, and terminated.

5. The method of claim 4, wherein transitions between relationship states further govern discovery visibility and event eligibility for the first user and the second user.

6. The method of claim 1, further comprising enabling, responsive to the relationship state being active, at least one communication channel between the first user and the second user, wherein availability of the at least one communication channel is gated based on both the relationship state and a trust tier associated with the relationship object.

7. The method of claim 6, wherein the trust tier is progressively elevated responsive to positive relationship health signals derived from the experiential participation data and the post-interaction feedback.

8. The method of claim 1, wherein the updating comprises recording co-participation data in the relationship object responsive to the first user and the second user jointly participating in a family-oriented experience, and collecting the post-interaction feedback from at least one of the first user and the second user following the family-oriented experience.

9. The method of claim 1, further comprising monitoring communications between the first user and the second user for prohibited content and, responsive to detecting a violation, triggering a safety action comprising at least one of suspending the relationship object, restricting communication permissions, or escalating to a moderation queue.

10. A system for forming and managing virtual family relationships, the system comprising:
one or more processors; and
a non-transitory storage medium storing processor-executable instructions that, when executed by the one or more processors, cause the system to implement:
a profile module configured to receive and store structured profile data and a family-role selection from each of a plurality of users, the family-role selection drawn from a predefined family-role taxonomy comprising a plurality of distinct family roles;
a role compatibility ruleset comprising at least one constraint table defining permitted pairings and prohibited pairings among the plurality of distinct family roles;
a matching engine configured to identify, for a given user, candidate users whose stored family-role selections correspond to a complementary family-role pairing as defined by the role compatibility ruleset, and to calculate for each candidate user a compatibility score;
a discovery interface configured to present ranked candidate profiles to the given user based on the calculated compatibility scores;
a relationship management module configured to, upon mutual acceptance between users, generate a persistent role-labelled relationship object comprising a family-role label and a relationship state, wherein transitions between relationship states govern at least communication permissions; and
an experiences module configured to surface family-oriented experiences and to update one or more parameters of a matching model based at least in part on experiential participation data and post-interaction feedback, thereby establishing a reinforcement feedback loop in which shared experiential participation influences subsequent compatibility scoring performed by the matching engine.

11. The system of claim 10, wherein the family-role taxonomy comprises at least parent roles, child roles, sibling roles, and grandparent roles.

12. The system of claim 10, wherein the matching engine calculates the compatibility score based on a plurality of weighted parameters comprising at least role compatibility, age alignment, and geographic proximity.

13. The system of claim 10, wherein the relationship object is distinct from friend, follower, and contact graph associations, and wherein the relationship state is selectable from at least active, suspended, and terminated.

14. The system of claim 10, further comprising a communication module configured to enable at least one communication channel between users having an active relationship object, wherein availability of the at least one communication channel is gated based on both the relationship state and a trust tier associated with the relationship object.

15. The system of claim 14, wherein the trust tier is progressively elevated responsive to positive relationship health signals derived from the experiential participation data and the post-interaction feedback.

16. A non-transitory computer-readable medium storing processor-executable instructions that, when executed by one or more processors, cause the one or more processors to perform operations comprising:
receiving, from each of a plurality of users, structured profile data and a selection of at least one desired family role from a predefined family-role taxonomy comprising a plurality of distinct family roles;
for a first user, querying a role compatibility ruleset comprising at least one constraint table defining permitted pairings and prohibited pairings among the plurality of distinct family roles to identify candidate users having a complementary family-role pairing;
calculating, for each identified candidate user, a compatibility score and presenting ranked candidate profiles to the first user via a discovery interface;
upon mutual acceptance between the first user and a second user, generating a persistent role-labelled relationship object comprising a family-role label derived from the respective family-role selections of the first user and the second user and a relationship state, wherein transitions between relationship states govern at least communication permissions; and
surfacing family-oriented experiences to the first user and the second user, and updating one or more parameters of a matching model based at least in part on experiential participation data and post-interaction feedback, thereby establishing a reinforcement feedback loop in which shared experiential participation influences subsequent compatibility scoring.

17. The non-transitory computer-readable medium of claim 16, wherein the family-role taxonomy comprises at least parent roles, child roles, sibling roles, and grandparent roles.

18. The non-transitory computer-readable medium of claim 16, wherein the relationship object is distinct from friend, follower, and contact graph associations, and wherein the relationship state is selectable from at least active, suspended, and terminated.

19. The non-transitory computer-readable medium of claim 16, further comprising enabling communication between the first user and the second user through at least one communication channel gated based on both the relationship state and a trust tier associated with the relationship object.

20. The non-transitory computer-readable medium of claim 16, wherein the operations further comprise monitoring communications for prohibited content and triggering a safety action responsive to detecting a violation.
